(19) United States
(12) Patent Application Publication
(10) Pub. No.: US 2026/0029592 A1
(43) Pub. Date: Jan. 29, 2026

(54) OPTICAL MODULE

(71) Applicant: HISENSE BROADBAND MULTIMEDIA TECHNOLOGIES CO., LTD., Qingdao (CN)

(72) Inventors: Sigeng YANG, Qingdao (CN); Xuxia LIU, Qingdao (CN); Fenglai WANG, Qingdao (CN); Peng HE, Qingdao (CN); Xiaolei MA, Qingdao (CN); He ZHAO, Qingdao (CN)

(21) Appl. No.: 19/344,025

(22) Filed: Sep. 29, 2025

Related U.S. Application Data
(63) Continuation of application No. PCT/CN2024/100714, filed on Jun. 21, 2024.

(30) Foreign Application Priority Data
Jun. 30, 2023 (CN) 202310790220.8
Jun. 30, 2023 (CN) 202310791657.3
Jun. 30, 2023 (CN) 202321691824.9

(51) Int. Cl. G02B 6/42

(52) U.S. Cl. CPC G02B 6/4246

(57) ABSTRACT

An optical module includes: a circuit board provided with optical emission and reception chips; and a lens assembly having a bottom connected to the circuit board and covering the optical emission and reception chips. The lens assembly includes a lens assembly body, first and second optical fiber adapters arranged at a first end of the lens assembly body and configured to transmit emission optical signal and reception optical signal, respectively. A distance between centers of the optical emission chip and the optical reception chip, in a direction perpendicular to an optical axis of the first optical fiber adapter and an optical axis of the second optical fiber adapter, is less than a distance between optical axes of the first optical fiber adapter and the second optical fiber adapter. The lens assembly body is formed thereon with four optical surfaces.

This application is a continuation of International Application No. PCT/CN2024/100714, filed on Jun. 21, 2024, which claims priority to Chinese Patent Application No. 202310790220.8, filed with the China National Intellectual Property Administration on Jun. 30, 2023, to Chinese Patent Application No. 202310791657.3, filed with the China National Intellectual Property Administration on Jun. 30, 2023, and to Chinese Patent Application No. 202321691824.9, filed with the China National Intellectual Property Administration on Jun. 30, 2023. All of the above-mentioned applications are incorporated herein by reference in their entirety.

### FIELD OF THE INVENTION

The present disclosure relates to the field of optical fiber communication technology, and in particular, to an optical module.

### BACKGROUND OF THE INVENTION

With the development of new services and application models such as cloud computing, mobile Internet, and video, advances in optical communication technology have become increasingly important. In optical communication technology, the optical module is a device for enabling the conversion between optical and electrical signals, one of the key devices in optical communication equipment, and occupies a core position in optical communication. Currently, the packaging forms of optical modules include transistor-outline (TO) packaging and chip on board (COB) packaging.

In an optical module with a COB packaging structure, an optical emission chip and an optical reception chip are directly mounted on a circuit board, and a lens assembly is disposed above the optical emission chip and the optical reception chip to change a transmission direction of an optical signal emitted by the optical emission chip and a transmission direction of an optical signal to be received by the optical reception chip, thereby enabling the optical module to emit and receive the optical signal.

### SUMMARY OF THE INVENTION

The optical module provided in the present disclosure includes:
a circuit board, where a surface of the circuit board is disposed thereon with an optical emission chip and an optical reception chip; and
a lens assembly, having a bottom connected to the circuit board and covering the optical emission chip and the optical reception chip; where:
the lens assembly includes a lens assembly body, and a first optical fiber adapter and a second optical fiber adapter that are arranged at a first end of the lens assembly body, where the first optical fiber adapter is configured to transmit an emission optical signal, and the second optical fiber adapter is configured to transmit a reception optical signal;
a distance between a center of the optical emission chip and a center of the optical reception chip, in a direction perpendicular to an optical axis of the first optical fiber adapter and an optical axis of the second optical fiber adapter, is less than a distance between the optical axis of the first optical fiber adapter and the optical axis of the second optical fiber adapter;
the lens assembly body is formed thereon with a first optical surface, a second optical surface, a third optical surface, and a fourth optical surface, where the first optical surface faces the first optical fiber adapter; the second optical surface faces the first optical surface and the optical emission chip, and is located above the optical emission chip and between the optical axis of the first optical fiber adapter and the optical axis of the second optical fiber adapter; the third optical surface faces the second optical fiber adapter; the fourth optical surface faces the third optical surface and the optical reception chip; and the optical reception chip is located below the fourth optical surface and between the optical axis of the first optical fiber adapter and the optical axis of the second optical fiber adapter.

### BRIEF DESCRIPTION OF THE DRAWINGS

To more clearly illustrate the technical solution in the embodiments of the present disclosure, the accompanying drawings that need to be used in the description of the embodiments or the prior art will be briefly introduced below. Apparently, the accompanying drawings in the description below merely illustrate some embodiments of the present disclosure. Those of ordinary skill in the art may also derive other accompanying drawings from these accompanying drawings without creative efforts.

FIG. 1 is a partial structural diagram of an optical communication system according to some embodiments of the present disclosure;

FIG. 2 is a partial structural diagram of a host computer according to some embodiments of the present disclosure;

FIG. 3 is a structural diagram of an optical module according to some embodiments of the present disclosure;

FIG. 4 is an exploded view of an optical module according to some embodiments of the present disclosure;

FIG. 5 is a schematic assembly diagram of a lens assembly and a circuit board according to some embodiments of the present disclosure;

FIG. 6 is a schematic diagram of a partial structure of a circuit board according to some embodiments of the present disclosure;

FIG. 7 is a schematic exploded view of a lens assembly and a circuit board according to some embodiments of the present disclosure;

FIG. 8 is a first schematic structural diagram of a lens assembly according to some embodiments of the present disclosure;

FIG. 9 is a second schematic structural diagram of a lens assembly according to some embodiments of the present disclosure;

FIG. 10 is a third schematic structural diagram of a lens assembly according to some embodiments of the present disclosure;

FIG. 11 is a fourth schematic structural diagram of a lens assembly according to some embodiments of the present disclosure;

FIG. 12 is a first cross-sectional view of a lens assembly according to some embodiments of the present disclosure;

FIG. 13 is a second cross-sectional view of a lens assembly according to some embodiments of the present disclosure;

FIG. 14 is a schematic diagram of a partial structure of a lens assembly body according to some embodiments of the present disclosure;

FIG. 15 is a first cross-sectional view of a lens assembly in use according to some embodiments of the present disclosure;

FIG. 16 is a second cross-sectional view of a lens assembly in use according to some embodiments of the present disclosure;

FIG. 17 is a first cross-sectional view of another lens assembly in use according to some embodiments of the present disclosure;

FIG. 18 is a second cross-sectional view of another lens assembly in use according to some embodiments of the present disclosure;

FIG. 19 is a cross-sectional view of a lens assembly according to some embodiments of the present disclosure;

FIG. 20 is a first cross-sectional view of another lens assembly according to some embodiments of the present disclosure;

FIG. 21 is a second cross-sectional view of another lens assembly according to some embodiments of the present disclosure;

FIG. 22 is a first perspective view of yet another lens assembly according to some embodiments of the present disclosure;

FIG. 23 is a second perspective view of yet another lens assembly according to some embodiments of the present disclosure;

FIG. 24 is a first cross-sectional view of yet another lens assembly according to some embodiments of the present disclosure;

FIG. 25 is a third perspective view of yet another lens assembly according to some embodiments of the present disclosure;

FIG. 26 is a partial enlarged view at O in FIG. 25;

FIG. 27 is a second cross-sectional view of yet another lens assembly according to some embodiments of the present disclosure;

FIG. 28 is a partial enlarged view at P in FIG. 27;

FIG. 29 is a third cross-sectional view of yet another lens assembly according to some embodiments of the present disclosure;

FIG. 30 is a fourth cross-sectional view of yet another lens assembly according to some embodiments of the present disclosure;

FIG. 31 is a fifth cross-sectional view of yet another lens assembly according to some embodiments of the present disclosure;

FIG. 32 is a first bottom view of yet another lens assembly in use according to some embodiments of the present disclosure; and

FIG. 33 is a second bottom view of yet another lens assembly in use according to some embodiments of the present disclosure.

### DETAILED DESCRIPTION OF THE EMBODIMENTS

The technical solutions in some embodiments of the present disclosure will be clearly and completely described below with reference to the accompanying drawings. Apparently, the described embodiments are merely some rather than all of the embodiments of the present disclosure. All other embodiments obtained by those of ordinary skill in the art based on the embodiments provided in the present disclosure fall within the scope of protection of the present disclosure.

Unless the context requires otherwise, throughout the description and claims, the term “comprise” and other forms thereof, such as the third-person singular form “comprises” and the present participle form “comprising” are construed in an open, inclusive meaning, that is, “comprising, but not limited to.” In the description, the terms “one embodiment,” “some embodiments,” “exemplary embodiments,” “example,” “specific example,” or “some examples,” etc. are intended to indicate that a particular feature, structure, material, or characteristic related to the embodiment or example is included in at least one embodiment or example of the present disclosure. The schematic illustration of the above terms does not necessarily refer to the same embodiment or example. Furthermore, the specific features, structures, materials, or characteristics described may be included in any one or more embodiments or examples in any suitable manner.

Hereinafter, the terms “first” and “second” are for descriptive purposes only, and are not to be understood as indicating or implying relative importance or as implicitly indicating the number of technical features indicated. Thus, the use of terms like “first” and “second” to describe features can explicitly or implicitly encompass one or more of such features. In the description of embodiments of the present disclosure, unless otherwise specified, “a plurality” means two or more.

In describing some embodiments, the expressions “coupled” and “connected” and extensions thereof may be used. For example, in describing some embodiments, the term “connected” may be used to indicate that two or more components are in direct physical contact or electrical contact with each other. For another example, in describing some embodiments, the term “coupled” may be used to indicate that two or more components are in direct physical contact or electrical contact with each other. However, the term “coupled” or “communicatively coupled” may also indicate that two or more components are not in direct contact with each other, but still cooperate or interact with each other. The embodiments disclosed herein are not necessarily limited to the contents herein.

“At least one of A, B, and C” has the same meaning as “at least one of A, B, or C”, encompassing the following combinations of A, B, and C: only A, only B, only C, a combination of A and B, a combination of A and C, a combination of B and C, as well as a combination of A, B, and C.

“A and/or B” includes three combinations of only A, only B, and a combination of A and B.

The use of “suitable for” or “configured to” herein means open and inclusive language that does not exclude devices suitable for or configured to perform additional tasks or steps.

As used herein, “about,” “approximately,” or “approximately” includes a stated value as well as an average within an acceptable range of deviation from a particular value, where the acceptable range of deviation is determined by one of ordinary skill in the art taking into account the measurement in question and the error associated with the measurement of a particular amount (i.e., limitations of the measurement system).

In optical communication technology, in order to establish information transmission between information processing devices, it is necessary to load information onto light and use the propagation of light to achieve the transmission of information. Here, the light loaded with information is an optical signal. When the optical signal is transmitted in the information transmission devices, the loss of optical power can be reduced, such that high-speed, long-distance, and low-cost information transmission can be achieved. The signals that the information processing devices are able to recognize and process are electrical signals. The information processing devices usually include optical network units (ONUs), gateways, routers, switches, mobile phones, computers, servers, tablet computers, televisions, etc. The information transmission devices usually include optical fibers and optical waveguides.

The optical modules enable the conversion between optical signals and electrical signals from the information processing devices and the information transmission devices. For example, at least one of an optical signal input or an optical signal output of an optical module is connected to an optical fiber, and at least one of an electrical signal input or an electrical signal output of the optical module is connected to an optical network unit; a first optical signal from the optical fiber is transmitted to the optical module, and the optical module converts the first optical signal into a first electrical signal and transmits the first electrical signal to the optical network unit; and a second electrical signal from the optical network unit is transmitted to the optical module, and the optical module converts the second electrical signal into a second optical signal and transmits the second optical signal to the optical fiber. Since information can be transmitted through electrical signals between a plurality of information processing devices, at least one information processing device in the plurality of information processing devices is required to be directly connected to the optical module, and all information processing devices are not required to be directly connected to the optical module. Here, the information processing device directly connected to the optical module is referred to as a host computer of the optical module. In addition, the optical signal input or the optical signal output of the optical module can be referred to as an optical port, and the electrical signal input or the electrical signal output of the optical module can be referred to as an electrical port.

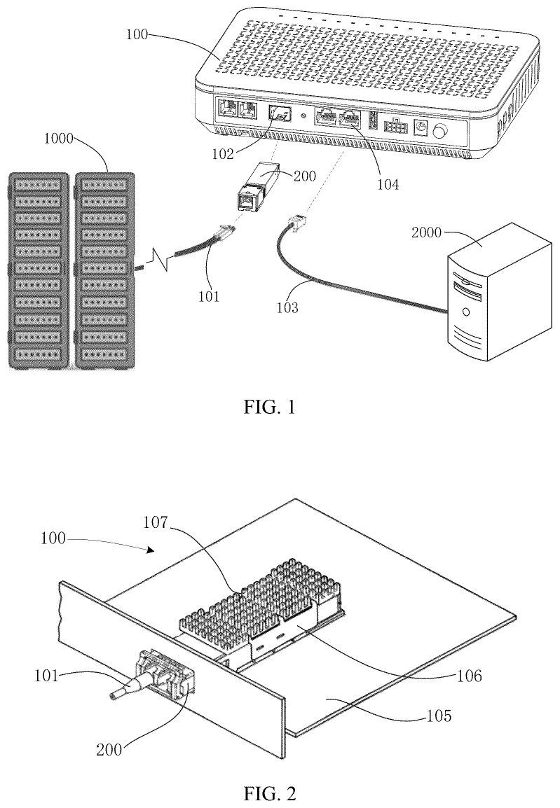

FIG. 1 is a partial structural diagram of an optical communication system according to some embodiments of the present disclosure. As shown in FIG. 1, the optical communication system primarily includes a remote information processing device 1000, a local information processing device 2000, a host computer 100, an optical module 200, an optical fiber 101 and a network cable 103.

One end of the optical fiber 101 extends toward the remote information processing device 1000, and the other end of the optical fiber 101 is connected to the optical module 200 via an optical port of the optical module 200. An optical signal can undergo total reflection in the optical fiber 101, and the propagation of the optical signal in a total reflection direction can make it nearly maintain its original optical power. The optical signal undergoes multiple total reflections in the optical fiber 101 to transmit an optical signal from the remote information processing device 1000 to the optical module 200 or to transmit an optical signal from the optical module 200 to the remote information processing device 1000, thereby achieving long-distance and low-power-loss information transmission.

The optical communication system may include one or more optical fibers 101, and the optical fiber 101 is detachably or fixedly connected to the optical module 200. The host computer 100 is configured to provide a data signal to the optical module 200, receive a data signal from the optical module 200, or monitor or control a working state of the optical module 200.

The host computer 100 includes a generally cuboid-shaped housing and an optical module interface 102 disposed on the housing. The optical module interface 102 is configured to be connected to the optical module 200, enabling the host computer 100 to establish a one-way or two-way electrical signal connection with the optical module 200.

The host computer 100 further includes an external electrical interface that can be connected to an electrical signal network. For example, the external electrical interface includes a universal serial bus (USB) interface or a network cable interface 104. The network cable interface 104 is configured to be connected to the network cable 103, enabling the host computer 100 to establish a one-way or two-way electrical signal connection with the network cable 103.

One end of the network cable 103 is connected to the local information processing device 2000, and the other end of the network cable 103 is connected to the host computer 100, thereby establishing an electrical signal connection between the local information processing device 2000 and the host computer 100 via the network cable 103. For example, a third electrical signal sent by the local information processing device 2000 is transmitted to the host computer 100 via the network cable 103. The host computer 100 generates a second electrical signal according to the third electrical signal. The second electrical signal from the host computer 100 is transmitted to the optical module 200. The optical module 200 converts the second electrical signal into a second optical signal and transmits the second optical signal to the optical fiber 101. The second optical signal is transmitted through the optical fiber 101 to the remote information processing device 1000. For example, a first optical signal from the remote information processing device 1000 is transmitted through the optical fiber 101. The first optical signal from the optical fiber 101 is transmitted to the optical module 200. The optical module 200 converts the first optical signal into a first electrical signal, and then the optical module 200 transmits the first electrical signal to the host computer 100. The host computer 100 generates a fourth electrical signal according to the first electrical signal and transmits the fourth electrical signal to the local information processing device 2000. It should be noted that the optical module is a tool to achieve the conversion between optical signals and electrical signals. In the conversion between the optical signals and the electrical signals, the information remains unchanged, and the encoding and decoding methods for the information may vary.

In addition to the optical network unit, the host computer 100 further includes an optical line terminal (OLT), an optical network terminal (ONT), or a data center server.

FIG. 2 is a partial structural diagram of a host computer according to some embodiments. To clearly show the connection relationship between the optical module 200 and the host computer 100, FIG. 2 shows only the structure of the host computer 100 related to the optical module 200. As shown in FIG. 2, the host computer 100 further includes a printed circuit board (PCB) 105 disposed in the housing, a cage 106 disposed on a surface of the PCB 105, a heat sink 107 disposed on the cage 106, and an electrical connector disposed inside the cage 106. The electrical connector is configured to be connected to the electrical port of the optical module 200. The heat sink 107 has protruding structures such as fins that enlarge the heat dissipation area.

The optical module 200 is inserted into the cage 106 of the host computer 100, and the optical module 200 is fixed by the cage 106. Heat generated by the optical module 200 is conducted to the cage 106 and then diffused through the heat sink 107. After the optical module 200 is inserted into the cage 106, the electrical port of the optical module 200 is connected to the electrical connector inside the cage 106, such that the optical module 200 establishes a two-way electrical signal connection with the host computer 100. In addition, the optical port of the optical module 200 is connected to the optical fiber 101, such that the optical module 200 establishes a two-way optical signal connection with the optical fiber 101.

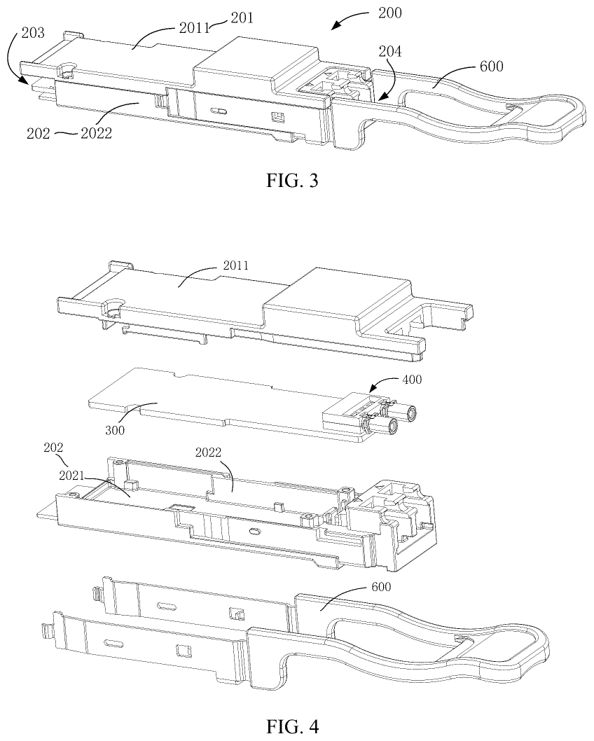

FIG. 3 is a structural diagram of an optical module according to some embodiments of the present disclosure. FIG. 4 is an exploded view of an optical module according to some embodiments of the present disclosure. As shown in FIG. 3 and FIG. 4, the optical module 200 includes a shell, and a circuit board 300 and a lens assembly 400 disposed in the shell.

The shell includes an upper shell 201 and a lower shell 202, where the upper shell 201 is covered on the lower shell 202 to form the shell with an opening 203 and an opening 204; and the outer contour of the shell is generally square.

In some embodiments, the lower shell 202 includes a bottom plate 2021 and two lower side plates 2022 located at two sides of the bottom plate 2021 and perpendicular to the bottom plate 2021; and the upper shell 201 includes a cover plate 2011, where the cover plate 2011 is covered on the two lower side plates 2022 of the lower shell 202 to form the shell.

In some embodiments, the lower shell 202 includes a bottom plate 2021 and two lower side plates 2022 located at two sides of the base plate 2021 and perpendicular to the bottom plate 2021; and the upper shell 201 includes a cover plate 2011 and two upper side plates located at two sides of the cover plate 2011 and perpendicular to the cover plate 2011, where the two upper side plates and the two lower side plates 2022 are combined to ensure that the upper shell 201 is covered on the lower shell 202.

A direction of a connecting line between the opening 203 and the opening 204 may be consistent with a length direction of the optical module 200 or may be inconsistent with the length direction of the optical module 200. For example, the opening 203 is located at an end of the optical module 200 (a left end of FIG. 3), and the opening 204 is also located at an end of the optical module 200 (a right end of FIG. 3). Alternatively, the opening 203 is located at an end of the optical module 200, and the opening 204 is located at a side of the optical module 200. The opening 203 is an electrical port, and a gold finger of the circuit board 300 extends out from the electrical port and is inserted into the host computer (e.g., an optical network unit 100); and the opening 204 is an optical port, which is configured to access the optical fiber 101 such that the optical fiber 101 is connected into the optical module 200.

The assembly method of combining the upper shell 201 with the lower shell 202 is adopted, such that the circuit board 300, the lens assembly 400 and other components can be conveniently mounted in the shell, and these components can be packaged and protected by the upper shell 201 and the lower shell 202. In addition, when the circuit board 300, the lens assembly 400, and other components are assembled, it facilitates deployment of positioning parts, heat dissipation parts, and electromagnetic shielding parts of these components, which is conducive to automated implementation of production.

In some embodiments, the upper shell 201 and the lower shell 202 are made of metal materials, which is conducive to electromagnetic shielding and heat dissipation.

In some embodiments, the optical module 200 further includes an unlocking component 600 located outside the shell. The unlocking component 600 is configured to achieve a fixed connection between the optical module 200 and the host computer, or to release the fixed connection between the optical module 200 and the host computer.

For example, the unlocking component 600 is located outside the two lower side plates 2022 of the lower shell 202, and includes an engaging component that matches the cage 106 of the host computer 100. When the optical module 200 is inserted into the cage 106, the optical module 200 is fixed in the cage 106 by the engaging component of the unlocking component 600; and when the unlocking component 600 is pulled, the engaging component of the unlocking component 600 moves accordingly, such that the connection relationship between the engaging component and the host computer is changed to release the fixation of the optical module 200 to the host computer, thereby pulling out the optical module 200 from the cage 106.

The circuit board 300 includes circuit traces, electronic components, and chips, where the electronic components and the chips are connected together through the circuit traces according to the circuit design to implement the functions such as power supply, electrical signal transmission, and grounding. The electronic components include, for example, capacitors, resistors, transistors, and metal-oxide-semiconductor field-effect transistors (MOSFETs). The chips include, for example, lasers, photodetectors, microcontroller units (MCUs), laser driver chips, limiting amplifiers (LAs), clock and data recovery (CDR) chips, power management chips, and digital signal processing (DSP) chips.

The circuit board 300 is generally a rigid circuit board. The rigid circuit board can also achieve a bearing effect because of its relatively hard material, for example, the rigid circuit board can stably carry the above-mentioned electronic components and chips. The rigid circuit board can also be inserted into the electrical connector in the cage 106 of the host computer 100.

The circuit board 300 further includes a gold finger formed on its end surface, where the gold finger consists of a plurality of pins that are independent of each other. The circuit board 300 is inserted into the cage 106 and is connected to the electrical connector in the cage 106 via the gold finger. The gold finger may be disposed only on a side surface of the circuit board 300 (such as an upper surface shown in FIG. 4), or may be disposed on upper and lower side surfaces of the circuit board 300 to provide more pins, so as to adapt to occasions requiring a large number of pins. The gold finger is configured to establish an electrical connection with the host computer to achieve power supply, grounding, two-wire inter-integrated circuit (I2C) signal transmission, data signal transmission, etc. Certainly, flexible circuit boards are also used in some optical modules. Flexible circuit boards are generally used in conjunction with rigid circuit boards as a supplement to rigid circuit boards.

In some embodiments, the lens assembly 400 is connected to the circuit board 300 and covers the optical emission chip and/or the optical reception chip; and the lens assembly 400 has a transmissive surface and a reflective surface, such that a transmission direction of an emission optical signal and/or a reception optical signal can be adjusted by combining the transmissive surface and the reflective surface, thereby enabling the emission optical signal generated by the optical emission chip to be output from the optical module, and the optical signal input to the optical module to be transmitted to the optical reception chip. The optical emission chip is, for example, a laser, and the optical reception chip is, for example, a photodetector. In addition to the optical emission chip and/or the optical reception chip, components such as a photoelectric monitoring part and a driver chip can be disposed below the lens assembly 400.

In some embodiments, the optical module 200 includes one lens assembly 400, where the lens assembly 400 covers the optical emission chip and the optical reception chip to adjust the transmission directions of the emission optical signal and the reception optical signal. Certainly, in some embodiments, the number of lens assemblies 400 in the optical module 200 is not limited to one, and there may be two lens assemblies 400, where an optical emission chip and/or an optical reception chip are/is disposed below each lens assembly 400.

In some embodiments, the lens assembly 400 is disposed at an end of the circuit board 300, such as a position close to the optical port. However, in some embodiments of the present disclosure, the lens assembly 400 is not limited to being disposed at the end of the circuit board 300, and the lens assembly 400 may also be disposed in a middle of the circuit board 300.

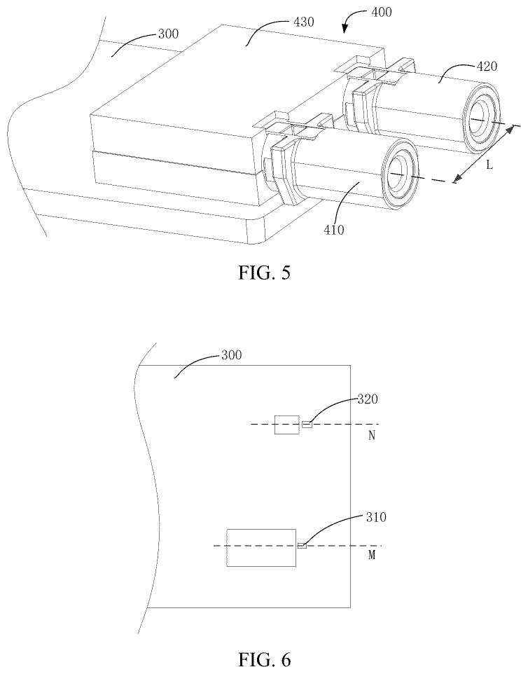

FIG. 5 is a schematic assembly diagram of a lens assembly and a circuit board according to some embodiments of the present disclosure. In some embodiments, as shown in FIG. 5, the lens assembly 400 includes a first optical fiber adapter 410, a second optical fiber adapter 420, and a lens assembly body 430. The first optical fiber adapter 410 is connected to one side of a first end of the lens assembly body 430, and the second optical fiber adapter 420 is connected to the other side of the first end of the lens assembly body 430, that is, the first optical fiber adapter 410 and the second optical fiber adapter 420 are arranged side by side at the first end of the lens assembly body 430. The first optical fiber adapter 410 and the second optical fiber adapter 420 are respectively configured to be connected to the optical fiber 101 to transmit the emission optical signal to the optical fiber 101 or to transmit the reception optical signal to the lens assembly body 430. By way of example, the first optical fiber adapter 410 is configured to transmit the emission optical signal to the optical fiber 101, and the second optical fiber adapter 420 is configured to transmit the reception optical signal to the optical fiber 101. Certainly, in some embodiments, one optical fiber adapter is disposed on the lens assembly 400, and two lens assemblies 400 are disposed in the optical module 200.

In some embodiments, a distance between an optical axis of the first optical fiber adapter 410 and an optical axis of the second optical fiber adapter 420 is a preset value, for example, the distance L between the optical axis of the first optical fiber adapter 410 and the optical axis of the second optical fiber adapter 420 is 6.25 mm. Even if two lens assemblies 400 are disposed in the optical module 200, the distance between the optical axes of the optical fiber adapters on the two lens assemblies 400 shall also be a fixed value.

FIG. 6 is a schematic diagram of a partial structure of a circuit board according to some embodiments of the present disclosure. In some embodiments, as shown in FIG. 6, a top surface of the circuit board 300 is provided with an optical emission chip 310 and an optical reception chip 320, where a center of the optical emission chip 310 is located on a projection straight line of the optical axis of the first optical fiber adapter 410 on the top surface of the circuit board 300, and a center of the optical reception chip 320 is located on a projection straight line of the optical axis of the second optical fiber adapter 420 on the top surface of the circuit board 300, such that a distance between the center of the optical emission chip 310 and the center of the optical reception chip 320 is a preset value. It should be noted that the center of the optical emission chip 310 mainly refers to a center of an effective light-emitting surface, and the center of the optical reception chip 320 mainly refers to a center of an effective detection surface.

In some embodiments, the optical emission chip 310 and the optical reception chip 320 need to share a driver chip, and the length of the driver chip is less than the distance L. In order to ensure the performance of signal transmission, a bonded wire between the optical emission chip 310 and the driver chip and a bonded wire between the optical reception chip 320 and the driver chip shall not be too long, for example, they need to be controlled within 0.1 mm. Therefore, the distance between the center of the optical emission chip 310 and the center of the optical reception chip 320 needs to be less than the distance L.

In some embodiments, even if the optical emission chip 310 and the optical reception chip 320 do not share the driver chip, the distance between the center of the optical emission chip 310 and the center of the optical reception chip 320 also needs to be reduced to less than the distance L in order to facilitate the layout of other components. To satisfy the requirement that the distance between the center of the optical emission chip 310 and the center of the optical reception chip 320 is less than the distance L, a lens assembly is provided in an embodiment of the present application.

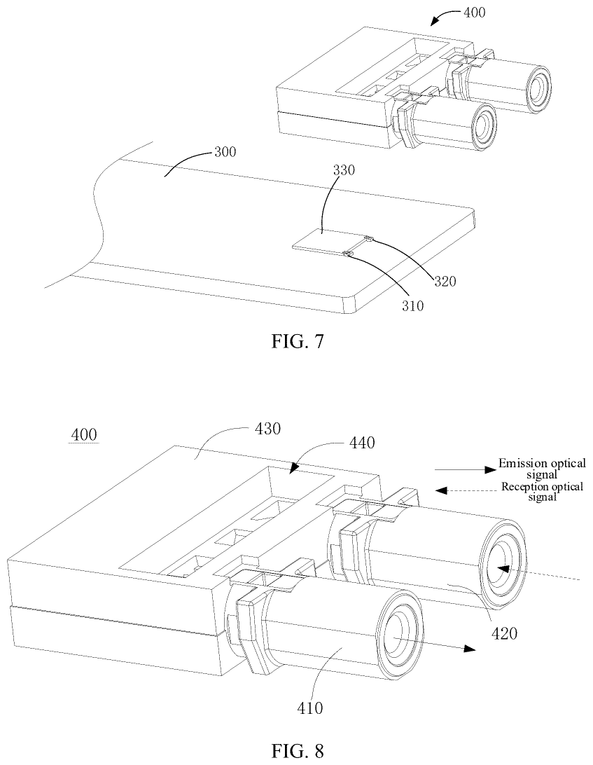

FIG. 7 is a schematic exploded view of a lens assembly and a circuit board according to some embodiments of the present disclosure. As shown in FIG. 7, the circuit board 300 is provided with an optical emission chip 310 and an optical reception chip 320, the distance between the center of the optical emission chip 310 and the center of the optical reception chip 320 is less than the distance L, and the lens assembly 400 is disposed above the optical emission chip 310 and the optical reception chip 320. By way of example, a bottom of the lens assembly 400 is connected to the circuit board 300, and the bottom of the lens assembly 400 and a surface of the circuit board 300 form a cavity, in which the optical emission chip 310 and the optical reception chip 320 are located. The lens assembly 400 can not only adjust the transmission direction of the emission optical signal from the optical emission chip 310 and the reception optical signal from the optical reception chip 320, but also protect the optical emission chip 310 and the optical reception chip 320.

In some embodiments, a projection of the optical axis of the first optical fiber adapter 410 on the circuit board 300 is a straight line M, and a projection of the optical axis of the second optical fiber adapter 420 on the circuit board 300 is a straight line N; a distance between the straight line M and the straight line N is L; and the optical emission chip 310 and the optical reception chip 320 are located between the straight line M and the straight line N. Certainly, in some embodiments, the center of the optical emission chip 310 is located on the straight line M or the center of the optical reception chip 320 is located on the straight line N.

In some embodiments, the circuit board 300 is further provided with a driver chip 330, where the driver chip 330 is disposed in the cavity formed by the bottom of the lens assembly 400 and the circuit board 300, and the driver chip 330 is located at one side of the optical emission chip 310 and the optical reception chip 320 away from the optical port of the optical module 200. By way of example, the driver chip 330 is disposed on one side of the optical emission chip 310 and the optical reception chip 320 away from the optical port; and the driver chip 330 is electrically connected to the optical emission chip 310 and the optical reception chip 320, respectively, that is, the optical emission chip 310 and the optical reception chip 320 share the driver chip 330. Certainly, in some embodiments, the circuit board is provided with two driver chips, where one driver chip is wire-bonded to the optical emission chip 310, and the other driver chip is wire-bonded to the optical reception chip 320.

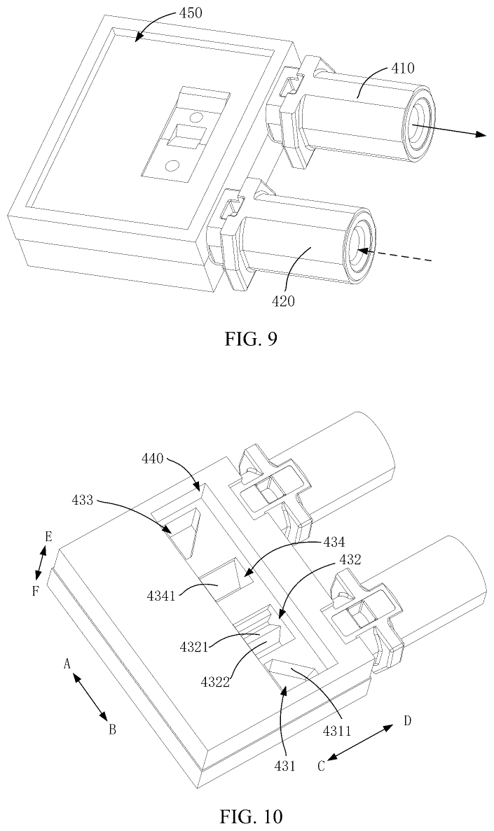

FIG. 8 is a first schematic structural diagram of a lens assembly according to some embodiments of the present disclosure. FIG. 9 is a second schematic structural diagram of a lens assembly according to some embodiments of the present disclosure. As shown in FIG. 8 and FIG. 9, in some embodiments, the lens assembly 400 includes a first optical fiber adapter 410, a second optical fiber adapter 420, and a lens assembly body 430. A plurality of optical surfaces are formed on the lens assembly body 430 to transmit or reflect the optical signal. A first end of the lens assembly body 430 is close to the optical port of the optical module 200, and a second end of the lens assembly body 430 is close to the electrical port of the optical module 200.

In some embodiments, the lens assembly 400 is a transparent plastic part, formed by means of integrated injection molding.

The first optical fiber adapter 410 is connected to one side of the first end of the lens assembly body 430, and the second optical fiber adapter 420 is connected to the other side of the first end of the lens assembly body 430, that is, the first optical fiber adapter 410 and the second optical fiber adapter 420 are arranged side by side at the first end of the lens assembly body 430. The first optical fiber adapter 410 and the second optical fiber adapter 420 have a hollow structure. The first optical fiber adapter 410 and the second optical fiber adapter 420 are configured to be connected to the optical fiber 101 to transmit the optical signal.

In some embodiments, fiber ferrules are respectively disposed inside the first optical fiber adapter 410 and the second optical fiber adapter 420 to improve the coupling efficiency of the optical signal between the optical fiber 101 and the lens assembly body 430.

As shown in FIG. 8, in some embodiments, a first recess portion 440 is formed at a top of the lens assembly body 430, and a plurality of optical surfaces are formed on a bottom of the first recess portion 440. By way of example, the first recess portion 440 is formed by a top surface of the lens assembly body 430 recessed toward a bottom of the lens assembly body 430. The first recess portion 440 is formed on the lens assembly body 430, and the optical surfaces are formed on the bottom of the first recess portion 440, such that a thickness at a position where the optical surfaces are disposed on the lens assembly body 430 can be adjusted via the first recess portion 440, thereby facilitating processing of the optical surfaces.

As shown in FIG. 9, in some embodiments, a second recess portion 450 is formed on the bottom of the lens assembly body 430, and the second recess portion 450 and the surface of the circuit board 300 form a cavity, which facilitates arrangement of the optical emission chip 310 and the optical reception chip 320 below the lens assembly 400. By way of example, the second recess portion 450 is formed by a bottom surface of the lens assembly body 430 recessed toward the top of the lens assembly body 430. In some embodiments, an optical surface is also formed on a top surface of the second recess portion 450, where the optical surface is mainly used for transmitting the optical signal, such as converging the optical signal.

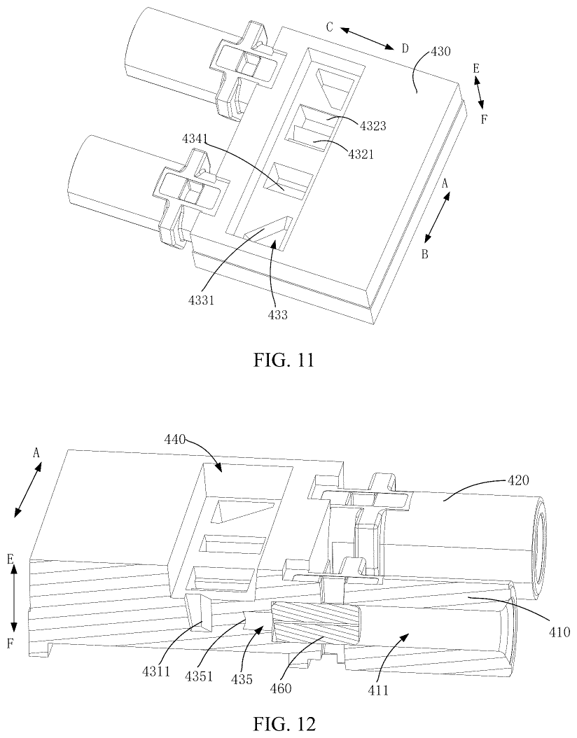

FIG. 10 is a third schematic structural diagram of a lens assembly according to some embodiments of the present disclosure. FIG. 11 is a fourth schematic structural diagram of a lens assembly according to some embodiments of the present disclosure. As shown in FIG. 10 and FIG. 11, a first groove 431 is formed at the top of the lens assembly body 430, and a first optical surface 4311 is formed on a side wall of the first groove 431. The first optical surface 4311 is located in an extension direction of the first optical fiber adapter 410. The first optical surface 4311 is used to reflect the emission optical signal to change the transmission direction of the emission optical signal.

In some embodiments, a projection of the first optical surface 4311 in the extension direction of the first optical fiber adapter 410 covers an end surface of a fiber ferrule in the first optical fiber adapter 410. By way of example, the first optical surface 4311 changes the transmission direction of the emission optical signal from an A-B direction to a C-D direction. In some embodiments, a reflective film is disposed on the first optical surface 4311 to improve the reflection efficiency of the first optical surface 4311 for the emission optical signal.

In some embodiments, the A-B direction of the lens assembly 400 is a width direction of the lens assembly 400, the C-D direction of the lens assembly 400 is a length direction of the lens assembly 400, and an E-F direction of the lens assembly 400 is a height direction of the lens assembly 400. By way of example, the width direction of the lens assembly 400 is parallel to a width direction of the circuit board 300, the length direction of the lens assembly 400 is parallel to a length direction of the circuit board 300, and the height direction of the lens assembly 400 is perpendicular to the top surface of the circuit board 300. Thus, the first optical surface 4311 changes the transmission direction of the emission optical signal in the width direction and the length direction of the circuit board 300.

As shown in FIG. 10 and FIG. 11, a second groove 432 is formed at the top of the lens assembly body 430, where the second groove 432 is located between the optical axis of the first optical fiber adapter 410 and the optical axis of the second optical fiber adapter 420; and a second optical surface 4321 is formed on a bottom of the second groove 432, where the second optical surface 4321 is used to reflect the emission optical signal to change the transmission direction of the emission optical signal. The second optical surface 4321 is located above the optical emission chip 310 and is configured to change the direction of the optical signal generated by the optical emission chip 310. In some embodiments, a projection of the second optical surface 4321 in a direction of the circuit board 300 covers the optical emission chip 310. In some embodiments, a reflective film is disposed on the second optical surface 4321 to improve the reflection efficiency of the second optical surface 4321.

In some embodiments of the present disclosure, the first optical surface 4311 and the second optical surface 4321 are combined such that the optical emission chip 310 is disposed between the projection of the optical axis of the first optical fiber adapter 410 on the circuit board 300 and the projection of the optical axis of the second optical fiber adapter 420 on the circuit board 300. Thus, even if the center of the optical emission chip 310 is not on the straight line M, the emission optical signal generated by the optical emission chip 310 can still be transmitted via the first optical fiber adapter 410.

As shown in FIG. 10 and FIG. 11, a third groove 433 is formed at the top of the lens assembly body 430, and a third optical surface 4331 is formed on a side wall of the third groove 433. The third optical surface 4331 is located in an extension direction of the second optical fiber adapter 420. The third optical surface 4331 is used to reflect the reception optical signal to change the transmission direction of the reception optical signal.

In some embodiments, a projection of the third optical surface 4331 in the extension direction of the second optical fiber adapter 420 covers an end surface of a fiber ferrule in the second optical fiber adapter 420. By way of example, the third optical surface 4331 changes the transmission direction of the reception optical signal from the C-D direction to the A-B direction, that is, the third optical surface 4331 changes the transmission direction of the reception optical signal in the length direction and the width direction of the circuit board 300. In some embodiments, a reflective film is disposed on the third optical surface 4331 to improve the reflection efficiency of the third optical surface 4331 for the reception optical signal.

As shown in FIG. 10 and FIG. 11, a fourth groove 434 is formed at the top of the lens assembly body 430, where the fourth groove 434 is located between the optical axis of the first optical fiber adapter 410 and the optical axis of the second optical fiber adapter 420; and a fourth optical surface 4341 is formed on a side wall of the fourth groove 434, where the fourth optical surface 4341 is used to reflect the reception optical signal to change the transmission direction of the reception optical signal. The fourth optical surface 4341 is located above the optical reception chip 320, and the fourth optical surface 4341 reflects and transmits the reception optical signal to the optical reception chip 320. In some embodiments, a projection of the fourth optical surface 4341 in the direction of the circuit board 300 covers the optical reception chip 320. In some embodiments, a reflective film is disposed on the fourth optical surface 4341 to improve the reflection efficiency of the fourth optical surface 4341 for the reception optical signal.

In some embodiments of the present disclosure, the third optical surface 4331 and the fourth optical surface 4341 are combined such that the optical reception chip 320 is disposed between the projection of the optical axis of the first optical fiber adapter 410 on the circuit board 300 and the projection of the optical axis of the second optical fiber adapter 420 on the circuit board 300. Thus, even if the center of the optical reception chip 320 is not on the straight line N, the reception optical signal input via the second optical fiber adapter 420 can still be transmitted to the optical reception chip 320.

In some embodiments, a fifth optical surface 4322 is further formed on the bottom of the second groove 432, where the fifth optical surface 4322 is capable of transmitting and reflecting the emission optical signal. An emission optical signal transmitted through the fifth optical surface 4322 is transmitted in a direction of the first optical surface 4311, and an optical signal reflected by the fifth optical surface 4322 is used for emission optical power monitoring of the optical module. In some embodiments, the second optical surface 4321 and the fifth optical surface 4322 intersect in the second groove 432. By way of example, a backlight monitor chip is disposed on the circuit board 300, the lens assembly 400 is located above the backlight monitor chip, and the backlight monitor chip receives the optical signal reflected by the fifth optical surface 4322 and performs emission optical power monitoring of the optical module.

In some embodiments, a sixth optical surface 4323 is further formed on a side wall of the second groove 432, where the sixth optical surface 4323 is used to transmit the emission optical signal transmitted through the fifth optical surface 4322 in the direction of the first optical surface 4311.

In some embodiments of the present disclosure, the lens assembly body 430 is formed thereon with the first groove 431, the second groove 432, the third groove 433, and the fourth groove 434, such that the thicknesses at respective positions of the lens assembly body 430 can be conveniently controlled, thereby facilitating formation of the corresponding optical surfaces, and making the optical surfaces convenient to process.

FIG. 12 is a first cross-sectional view of a lens assembly according to some embodiments of the present disclosure. As shown in FIG. 12, the first optical fiber adapter 410 is formed thereon with a first through hole 411, and a first fiber ferrule 460 is disposed in the first through hole 411. The first fiber ferrule 460 is configured to couple the optical signal from the lens assembly body 430 into the optical fiber 101, thereby improving the coupling efficiency of the emission optical signal into the optical fiber 101.

In some embodiments, the lens assembly body 430 is further formed thereon with a first blind hole 435, where one end of the first blind hole 435 is communicated to the first through hole 411, a first lens 4351 is disposed at another end of the first blind hole 435, and the first lens 4351 is configured to converge an emission optical signal reflected by the first optical surface 4311 to an end surface of the first fiber ferrule 460.

In some embodiments, the end surface of the first fiber ferrule 460 is an inclined surface, and an inclination angle of the end surface of the first fiber ferrule 460 is 4-7°, which reduces return of an optical signal reflected by the end surface of the first fiber ferrule 460 along a transmission optical path of the emission optical signal.

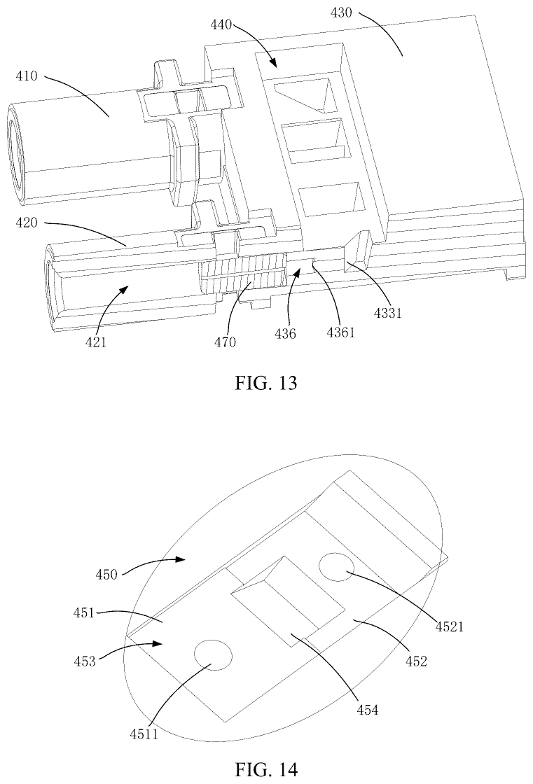

FIG. 13 is a second cross-sectional view of a lens assembly according to some embodiments of the present disclosure. As shown in FIG. 13, the second optical fiber adapter 420 is formed thereon with a second through hole 421, and a second fiber ferrule 470 is disposed in the second through hole 421. The second fiber ferrule 470 is configured to couple the optical signal from the optical fiber 101 into the lens assembly body 430, thereby improving the coupling efficiency of the reception optical signal into the lens assembly body 430.

In some embodiments, the lens assembly body 430 is further formed thereon with a second blind hole 436, where one end of the second blind hole 436 is communicated to the second through hole 421, a second lens 4361 is disposed at another end of the second blind hole 436, and the second lens 4361 is configured to collimate a reception optical signal output via an end surface of the second optical surface 470 to the third fiber ferrule 4331.

In some embodiments, the end surface of the second fiber ferrule 470 is an inclined surface, and an inclination angle of the end surface of the second fiber ferrule 470 is 4-7°, which reduces re-reflection of a reception optical signal reflected by the third optical surface 4331 back into a transmission optical path of the reception optical signal via the end surface of the second fiber ferrule 470.

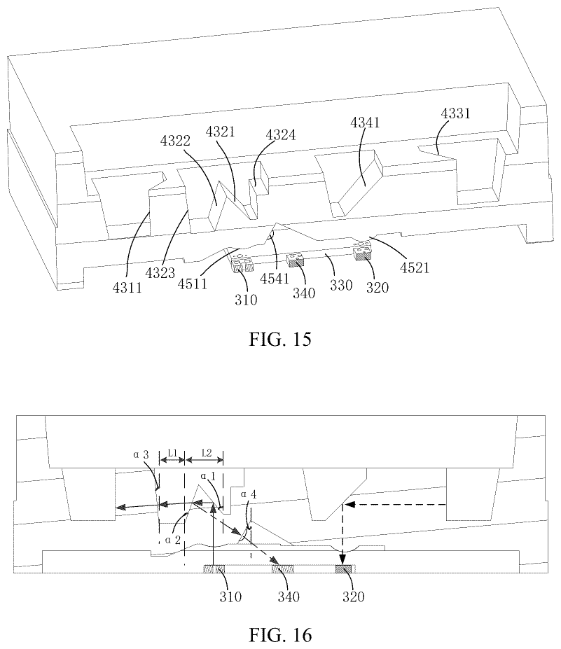

FIG. 14 is a schematic diagram of a partial structure of a lens assembly body according to some embodiments of the present disclosure. FIG. 15 is a cross-sectional view of a lens assembly in use according to some embodiments of the present disclosure. The optical emission chip 310 and the optical reception chip 320 are disposed between the projection of the optical axis of the first optical fiber adapter 410 on the circuit board 300 and the projection of the optical axis of the second optical fiber adapter 420 on the circuit board 300.

As shown in FIG. 14 and FIG. 15, a seventh optical surface 451 and an eighth optical surface 452 are disposed on the top surface of the second recess portion 450. The seventh optical surface 451 is located above the optical emission chip 310 and is configured to transmit the emission optical signal generated by the optical emission chip 310; and the eighth optical surface 452 is located above the optical reception chip 320 and is configured to transmit the reception optical signal, such that the reception optical signal is transmitted to the optical reception chip 320.

In some embodiments, a third lens 4511 is disposed on the seventh optical surface 451, where the third lens 4511 is configured to collimate the emission optical signal generated by the optical emission chip 310.

In some embodiments, a fourth lens 4521 is disposed on the eighth optical surface 452, where the fourth lens 4521 is configured to converge the reception optical signal to the optical reception chip 320.

In some embodiments, a fifth groove 453 is formed on the top surface of the second recess portion 450, and the seventh optical surface 451 and the eighth optical surface 452 are formed on a bottom surface of the fifth groove 453. Relative heights of the seventh optical surface 451 and the eighth optical surface 452, that is, a distance between the seventh optical surface 451 and a light-emitting surface of the optical emission chip 310, and a distance between the eighth optical surface 452 and a light-receiving surface of the optical reception chip 320, are adjusted via the fifth groove 453.

In some embodiments, a position of the first optical surface 4311, the second optical surface 4321, the fifth optical surface 4322, or the like is adjusted to adjust a position of the backlight monitor chip with respect to the optical emission chip 310 and the optical reception chip 320, such as making the backlight monitor chip located on a connecting line between the optical emission chip 310 and the optical reception chip 320, making the backlight monitor chip located between the optical emission chip 310 and the optical reception chip 320, or making the backlight monitor chip located at one side of the optical emission chip 310 away from the optical reception chip 320.

In some embodiments, a first backlight monitor chip 340 is further disposed below the lens assembly body 430, and a ninth optical surface 454 is further formed in the fifth groove 453, where the ninth optical surface 454 transmits an optical signal to the first backlight monitor chip 340, and the first backlight monitor chip 340 receives the optical signal to monitor emission optical power of the optical emission chip 310.

In some examples, the first backlight monitor chip 340 is located between the optical emission chip 310 and the optical reception chip 320, and the ninth optical surface 454 is located between the seventh optical surface 451 and the eighth optical surface 452.

In some embodiments, a fifth lens 4541 is disposed on the ninth optical surface 454, where the fifth lens 4541 is configured to converge the optical signal.

In some embodiments, the ninth optical surface 454 is an inclined surface, and a step surface 4324 is formed on the side wall of the second groove 432, where the step surface 4324 is located above the ninth optical surface 454, such that a thickness of the lens assembly body 430 above the ninth optical surface 454 is adjusted via the step surface 4324, thereby ensuring the formability of the ninth optical surface 454, and facilitating processing of the ninth optical surface 454.

FIG. 16 is a second cross-sectional view of a lens assembly in use according to some embodiments of the present disclosure. FIG. 16 shows a transmission optical path of a lens assembly 400. As shown in FIG. 16, the emission optical signal generated by the optical emission chip 310 is transmitted to the third lens 4511, collimated by the third lens 4511 and transmitted to the second optical surface 4321, reflected by the second optical surface 4321 and transmitted to the fifth optical surface 4322; the emission optical signal transmitted to the fifth optical surface 4322 is partially transmitted through the fifth optical surface 4322 and partially reflected by the fifth optical surface 4322; and the emission optical signal transmitted through the fifth optical surface 4322 is transmitted to the sixth optical surface 4323, passes through the sixth optical surface 4323 and is transmitted through the sixth optical surface 4323, and the emission optical signal transmitted through the sixth optical surface 4323 is transmitted to the first optical surface 4311 and finally reflected by the first optical surface 4311. The emission optical signal reflected by the fifth optical surface 4322 is transmitted to the ninth optical surface 454, converged by the fifth lens 4541 and transmitted to the first backlight monitor chip 340.

As shown in FIG. 16, the reception optical signal is transmitted to the third optical surface 4331, reflected by the third optical surface 4331 and transmitted to the fourth optical surface 4341, reflected by the fourth optical surface 4341 and transmitted to the eighth optical surface 452, converged by the fourth lens 4521 and transmitted to the optical reception chip 320.

In some embodiments of the present disclosure, with reference to a surface perpendicular to the light-emitting surface of the optical emission chip 310, an inclination angle of the second optical surface 4321 is α1, an inclination angle of the fifth optical surface 4322 is α2, an inclination angle of the sixth optical surface 4323 is α3, and an inclination angle of the ninth optical surface 454 is α4. The inclination angle α1 of the second optical surface 4321, the inclination angle α2 of the fifth optical surface 4322, the inclination angle α3 of the sixth optical surface 4323, and the inclination angle α4 of the ninth optical surface 454 are coordinated with each other, and their specific values shall be selected through mutual coordination with reference to the distances L1 and L2 between the optical surfaces. A distance between the first backlight monitor chip 340 and the optical emission chip 310 is combined with the inclination angle α1 of the second optical surface 4321, the inclination angle α2 of the fifth optical surface 4322, and the inclination angle α4 of the ninth optical surface 454. Accordingly, the selection of the inclination angle α1 of the second optical surface 4321, the inclination angle α2 of the fifth optical surface 4322, and the inclination angle α4 of the ninth optical surface 454 needs to take into account the distance between the first backlight monitor chip 340 and the optical emission chip 310.

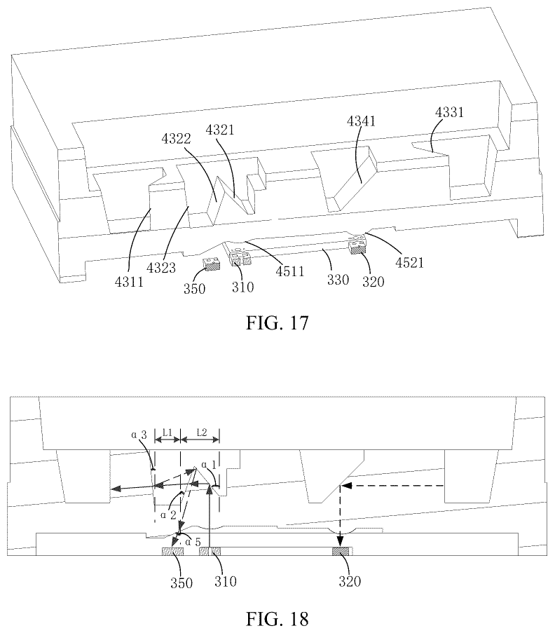

FIG. 17 is a first cross-sectional view of another lens assembly in use according to some embodiments of the present disclosure. As shown in FIG. 17, in some examples, a second backlight monitor chip 350 is disposed on a side of the optical emission chip 310 away from the optical reception chip 320; and a tenth optical surface is formed on the top surface of the second recess portion 450, where the tenth optical surface is located above the second backlight monitor chip 350. The tenth optical surface is used to transmit an optical signal and transmit it to the second backlight monitor chip 350; and the second backlight monitor chip 350 receives the optical signal to monitor emission optical power of the optical emission chip 310. By way of example, the optical signal transmitted to the tenth optical surface is refracted at the tenth optical surface, and the optical signal refracted by the tenth optical surface is transmitted to the second backlight monitor chip 350.

FIG. 18 is a second cross-sectional view of another lens assembly in use according to some embodiments of the present disclosure. FIG. 18 shows a transmission optical path of another lens assembly 400. As shown in FIG. 18, the emission optical signal generated by the optical emission chip 310 is transmitted to the third lens 4511, collimated by the third lens 4511 and transmitted to the second optical surface 4321, reflected by the second optical surface 4321 and transmitted to the fifth optical surface 4322, and transmitted through the fifth optical surface 4322 to the sixth optical surface 4323; the emission optical signal transmitted to the sixth optical surface 4323 is partially transmitted through the sixth optical surface 4323 and partially reflected by the sixth optical surface 4323; the emission optical signal transmitted through the sixth optical surface 4323 is transmitted to the first optical surface 4311 and finally reflected by the first optical surface 4311; and the optical signal reflected by the sixth optical surface 4323 is transmitted to the fifth optical surface 4322 and transmitted through the fifth optical surface 4322 to the second optical surface 4321, reflected by the second optical surface 4321 and transmitted to the tenth optical surface, and transmitted through the tenth optical surface to the second backlight monitor chip 350.

In some embodiments of the present disclosure, with reference to the surface perpendicular to the light-emitting surface of the optical emission chip 310, an inclination angle of the tenth optical surface is α5. The inclination angle α5 of the tenth optical surface needs to be selected in combination with the inclination angle α1 of the second optical surface 4321, the inclination angle α2 of the fifth optical surface 4322, and the inclination angle α3 of the sixth optical surface 4323. A distance between the second backlight monitor chip 350 and the optical emission chip 310 is combined with the inclination angle α1 of the second optical surface 4321, the inclination angle α2 of the fifth optical surface 4322, and the inclination angle α5 of the tenth optical surface. Accordingly, the selection of the inclination angle α1 of the second optical surface 4321, the inclination angle α2 of the fifth optical surface 4322, and the inclination angle α5 of the tenth optical surface needs to take into account the distance between the second backlight monitor chip 350 and the optical emission chip 310.

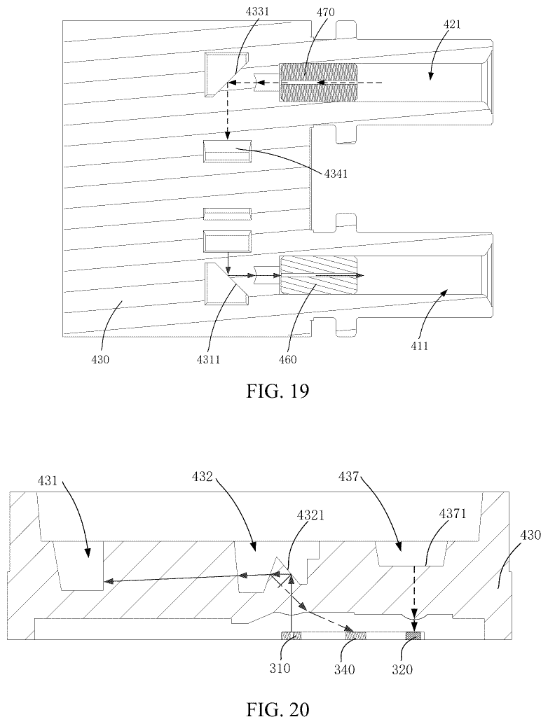

FIG. 19 is a cross-sectional view of a lens assembly according to some embodiments of the present disclosure. FIG. 19 shows a transmission optical path of a lens assembly 400. As shown in FIG. 19, the emission optical signal is transmitted through the fifth optical surface 4322 to the first optical surface 4311, reflected by the first optical surface 4311 and transmitted to the first lens 4351, converged by the first lens 4351 and transmitted to the first fiber ferrule 460, and transmitted along an extension direction of the first fiber ferrule 460.

As shown in FIG. 19, the reception optical signal is transmitted through the second fiber ferrule 470 to the second lens 4361, collimated by the second lens 4361 and transmitted to the third optical surface 4331, reflected by the third optical surface 4331 and transmitted to the fourth optical surface 4341.

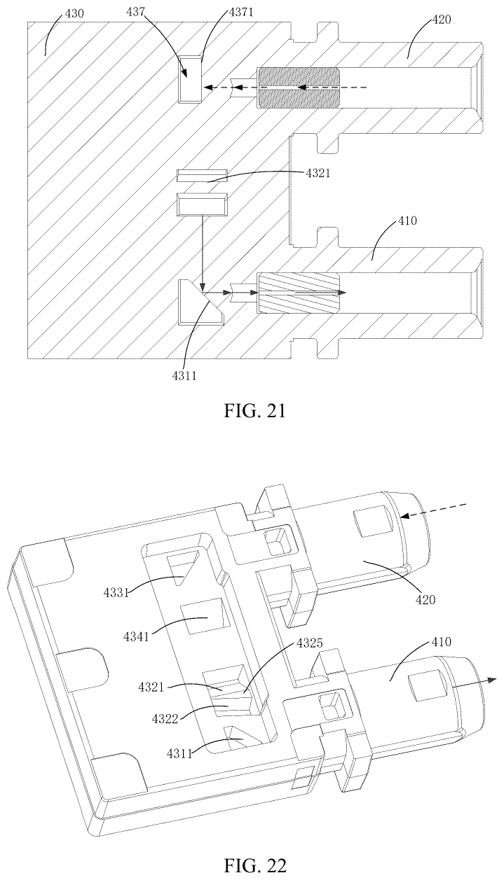

FIG. 20 is a first cross-sectional view of another lens assembly according to some embodiments of the present disclosure. FIG. 21 is a second cross-sectional view of another lens assembly according to some embodiments of the present disclosure. In some embodiments, as shown in FIG. 20 and FIG. 21, the center of the optical reception chip 320 is located on the projection of the optical axis of the second optical fiber adapter 420 in the direction of the circuit board 300, the optical reception chip 320 is formed thereon with a sixth groove 437, and an eleventh optical surface 4371 is formed in the sixth groove 437, where the eleventh optical surface 4371 is inclined in a direction of the second optical fiber adapter 420. The reception optical signal is transmitted through the second optical fiber adapter 420 to the eleventh optical surface 4371; and the eleventh optical surface 4371 reflects the reception optical signal to change the transmission direction of the reception optical signal from parallel to the circuit board 300 to perpendicular to the circuit board 300.

In some embodiments, the eleventh optical surface 4371 is located above the eighth optical surface 452, the optical reception chip 320 is located below the fourth lens 4521, and the reception optical signal reflected by the eleventh optical surface 4371 is transmitted to the fourth lens 4521, then converged by the fourth lens 4521 and transmitted to the optical reception chip 320.

To meet the requirements for the distance between the optical emission chip 310 and the optical reception chip 320, the optical emission chip 310 is close to a position where the projection of the optical axis of the second optical fiber adapter 420 on the circuit board 300 is located, that is, compared with the situation where the optical emission chip 310 and the optical reception chip 320 are located between the projection of the optical axis of the first optical fiber adapter 410 and the projection of the optical axis of the second optical fiber adapter 420 on the circuit board 300, the optical emission chip 310 is moved in the direction of the second optical fiber adapter 420, and accordingly, the second optical surface 4321 and others are moved in the same direction.

Certainly, in the embodiments of the present disclosure, the center of the optical emission chip 310 can also be close to or located at the projection of the optical axis of the first optical fiber adapter 410 on the circuit board 300, and the positions and combinations of the optical surfaces on the lens assembly 400 can be adaptively adjusted.

In some embodiments, the distance between the center of the optical emission chip 310 and the projection of the optical axis of the first optical fiber adapter 410 on the circuit board 300 is equal to the distance between the center of the optical reception chip 320 and the projection of the optical axis of the second optical fiber adapter 420 on the circuit board 300, such that an optical path length of the emission optical signal and an optical path length of the reception optical signal inside the optical module 200 are approximately the same, thereby facilitating balance of the optical path length of the emission optical signal and the optical path length of the reception optical signal inside the optical module 200, and enabling coordination of tolerances for the transmission optical path of the emission optical signal and the transmission optical path of the reception optical signal.

In some embodiments, the position of the first optical surface 4311, the second optical surface 4321, the fifth optical surface 4322, or the like is adjusted to ensure that the backlight monitor chip is not located on the connecting line between the optical emission chip 310 and the optical reception chip 320, thereby facilitating arrangement of the backlight monitor chip, such as reducing limitations of assembly space on selection of the backlight monitor chip.

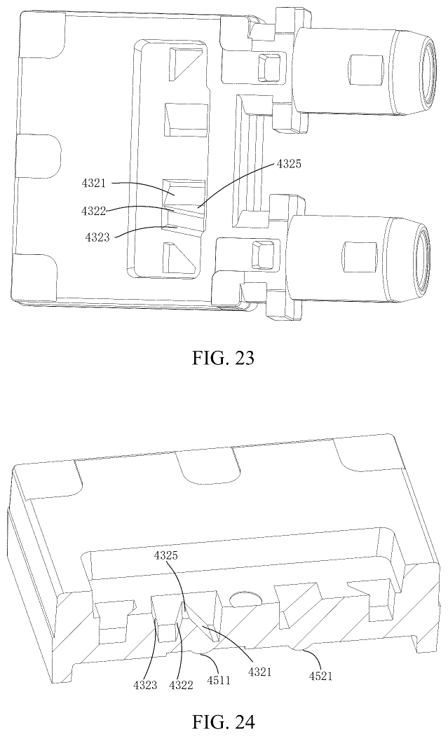

FIG. 22 is a first perspective view of yet another lens assembly according to some embodiments of the present disclosure. FIG. 23 is a second perspective view of yet another lens assembly according to some embodiments of the present disclosure. FIG. 24 is a first cross-sectional view of yet another lens assembly according to some examples of the present disclosure. In some embodiments, as shown in FIG. 22 and FIG. 23, a second optical surface 4321, a fifth optical surface 4322, and a sixth optical surface 4323 are formed on the bottom of the second groove 432, where the second optical surface 4321 and the fifth optical surface 4322 do not intersect in the second groove 432, that is, an intersection of the second optical surface 4321 and the fifth optical surface 4322 is not in the second groove 432.

By way of example, the second groove 432 is formed therein with a first plane 4325, the first plane 4325 is perpendicular to the optical axis of the optical emission chip 310, the second optical surface 4321 is located at one side of the first plane 4325, the fifth optical surface 4322 is located at another side of the first plane 4325, and the second optical surface 4321 and the fifth optical surface 4322 are not symmetric about a central axis of the first plane 4325.

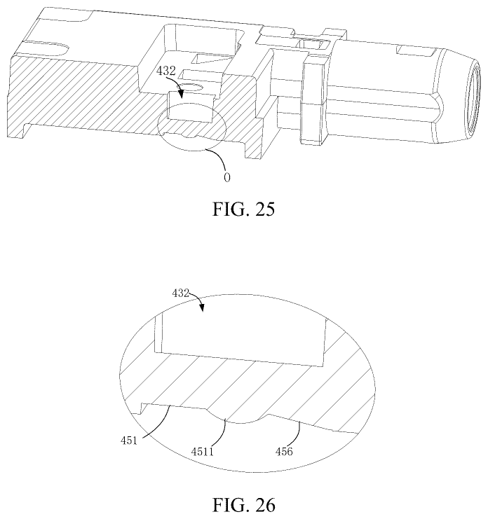

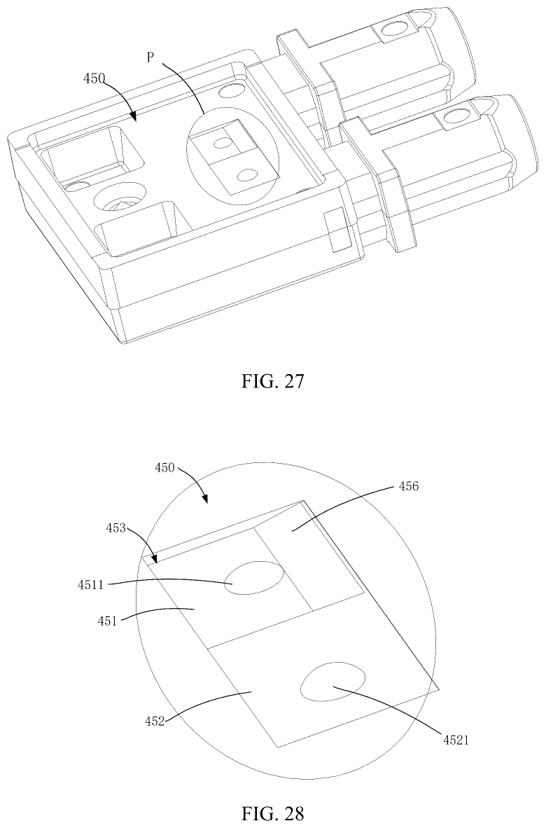

FIG. 25 is a third perspective view of yet another lens assembly according to some embodiments of the present disclosure. FIG. 26 is a partial enlarged view at O in FIG. 25. FIG. 27 is a second cross-sectional view of yet another lens assembly according to some embodiments of the present disclosure. FIG. 28 is a partial enlarged view at P in FIG. 27. As shown in FIG. 25 to FIG. 28, a side of the seventh optical surface 451 close to a front end of the lens assembly 400 is formed with a twelfth optical surface 456, the twelfth optical surface 456 is located below the second optical surface 4321, and the twelfth optical surface 456 is used to refract and transmit the optical signal. By way of example, the twelfth optical surface 456 refracts the optical signal used to monitor the emission optical power of the optical emission chip, thereby making an optical axis of the optical signal used to monitor the emission optical power of the optical emission chip deviate from the optical axis of the optical emission chip 310. In some embodiments, a bottom surface of the seventh optical surface 451 is formed thereon with a twelfth optical surface 456.

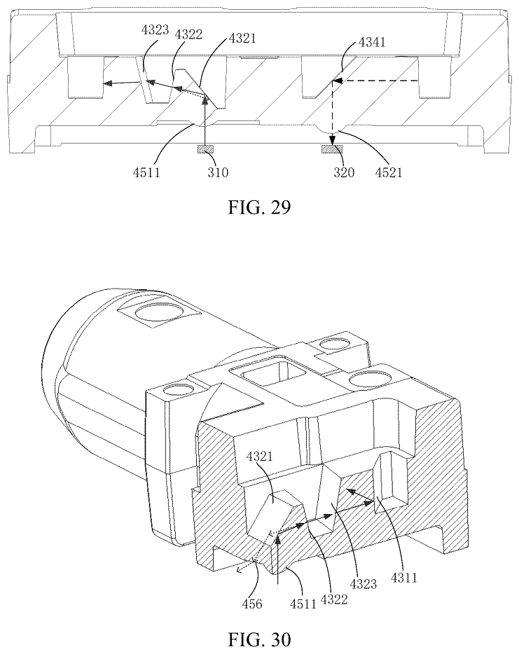

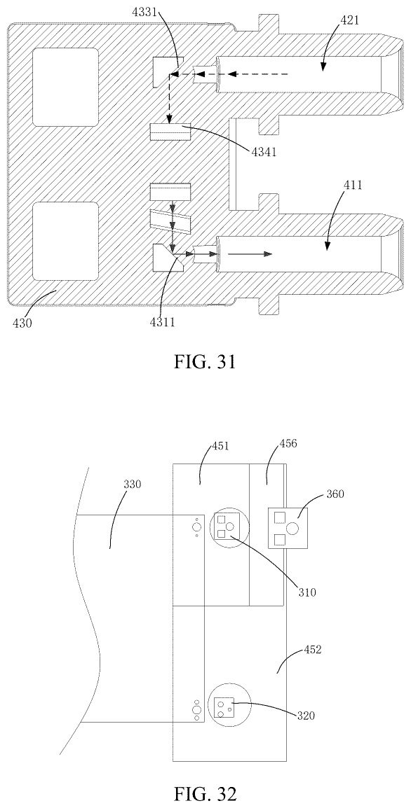

FIG. 29 is a third cross-sectional view of yet another lens assembly according to some embodiments of the present disclosure. FIG. 30 is a fourth cross-sectional view of yet another lens assembly according to some embodiments of the present disclosure. FIG. 31 is a fifth cross-sectional view of yet another lens assembly according to some embodiments of the present disclosure. FIG. 29 to FIG. 31 show transmission optical paths of yet another lens assembly 400. As shown in FIG. 29 and FIG. 30, the emission optical signal generated by the optical emission chip 310 is transmitted to the third lens 4511, collimated by the third lens 4511 and transmitted to the second optical surface 4321, reflected by the second optical surface 4321 and transmitted to the fifth optical surface 4322; the emission optical signal transmitted to the fifth optical surface 4322 is partially transmitted through the fifth optical surface 4322 and partially reflected by the fifth optical surface 4322; and the emission optical signal transmitted through the fifth optical surface 4322 is transmitted to the sixth optical surface 4323, passes through the sixth optical surface 4323 and is transmitted through the sixth optical surface 4323, and the emission optical signal transmitted through the sixth optical surface 4323 is transmitted to the first optical surface 4311 and finally reflected by the first optical surface 4311. The optical signal reflected by the fifth optical surface 4322 is transmitted to the second optical surface 4321, reflected by the second optical surface 4321 and transmitted to the twelfth optical surface 456, and transmitted through the twelfth optical surface 456 to the backlight monitor chip.

As shown in FIG. 29 and FIG. 31, the reception optical signal is transmitted to the third optical surface 4331, reflected by the third optical surface 4331 and transmitted to the fourth optical surface 4341, reflected by the fourth optical surface 4341 and transmitted to the eighth optical surface 452, converged by the fourth lens 4521 and transmitted to the optical reception chip 320.

FIG. 32 is a first bottom view of yet another lens assembly in use according to some embodiments of the present disclosure. As shown in FIG. 32, a third backlight monitor chip 360 is further disposed below the lens assembly 400, where the third backlight monitor chip 360 is located at a right side of the optical emission chip 310 and below the twelfth optical surface 456, and the third backlight monitor chip 360 is closer to the optical port of the optical module 200 than the optical emission chip 310. The third backlight monitor chip 360 is not located on the connecting line between the optical emission chip 310 and the optical reception chip 320, such that the third backlight monitor chip 360 is kept away from the driver chip 330, thus effectively preventing the arrangement of the third backlight monitor chip 360 from interfering with the layout of the driver chip 330, or effectively preventing the driver chip 330 from interfering with the layout of the third backlight monitor chip 360. For example, when the third backlight monitor chip 360 is selected to be relatively large in size, disposing the third backlight monitor chip 360 on the optical emission chip 310 can avoid assembly interference between the third backlight monitor chip 360 and the driver chip 330.

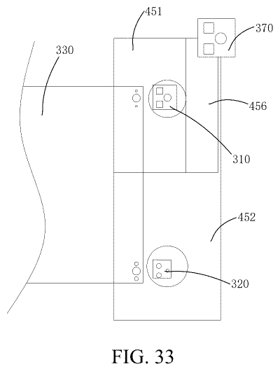

FIG. 33 is a second bottom view of yet another lens assembly in use according to some embodiments of the present disclosure. As shown in FIG. 33, in some embodiments, a fourth backlight monitor chip 370 is further disposed below the lens assembly 400, where the fourth backlight monitor chip 370 is located at an obliquely diagonal side of the optical emission chip 310, away from the optical reception chip 320, and below the twelfth optical surface 456, and the fourth backlight monitor chip 370 is closer to the optical port of the optical module 200 than the optical emission chip 310. The fourth backlight monitor chip 370 is not located on the connecting line between the optical emission chip 310 and the optical reception chip 320, such that the fourth backlight monitor chip 370 is kept away from the driver chip 330, thus effectively preventing the arrangement of the fourth backlight monitor chip 370 from interfering with the layout of the driver chip 330, or effectively preventing the driver chip 330 from interfering with the layout of the fourth backlight monitor chip 370.

In the optical module according to some embodiments of the present disclosure, the lens assembly 400 enables the optical emission chip 310 and the optical reception chip 320 to be disposed between the optical axis of the first optical fiber adapter 410 and the optical axis of the second optical fiber adapter 420, such that the optical emission chip 310 and the optical reception chip 320 can be close to each other, and the optical emission chip 310 and the optical reception chip 320 can share the driver chip 330.

Finally, it should be noted that the above embodiments are provided merely to illustrate the technical solutions of the present disclosure and not to limit them. Although the present disclosure has been described in detail with reference to the aforementioned embodiments, those of ordinary skill in the art should understand that they can still make modifications on the technical solutions described in the aforementioned embodiments or make equivalent replacements on some of the technical features; and these modifications or replacements do not make the essence of the corresponding technical solutions depart from the spirit and scope of the technical solutions of the various embodiments of the present disclosure.

1. An optical module, comprising:
a circuit board, wherein a surface of the circuit board is disposed thereon with an optical emission chip and an optical reception chip; and
a lens assembly, having a bottom connected to the circuit board and covering the optical emission chip and the optical reception chip; wherein:
the lens assembly comprises a lens assembly body, and a first optical fiber adapter and a second optical fiber adapter that are arranged at a first end of the lens assembly body, wherein the first optical fiber adapter is configured to transmit an emission optical signal, and the second optical fiber adapter is configured to transmit a reception optical signal;
a distance between a center of the optical emission chip and a center of the optical reception chip, in a direction perpendicular to an optical axis of the first optical fiber adapter and an optical axis of the second optical fiber adapter, is less than a distance between the optical axis of the first optical fiber adapter and the optical axis of the second optical fiber adapter;
the lens assembly body is formed thereon with a first optical surface, a second optical surface, a third optical surface, a fourth optical surface, a fifth optical surface and a sixth optical surface, wherein the first optical surface faces the first optical fiber adapter; the second optical surface faces the first optical surface and the optical emission chip, and is located above the optical emission chip and between the optical axis of the first optical fiber adapter and the optical axis of the second optical fiber adapter; the fifth optical surface and the sixth optical surface are located on an optical path from the second optical surface to the first optical surface, the fifth optical surface is capable of transmitting and reflecting the emission optical signal, and the emission optical signal transmitted through the fifth optical surface is transmitted to the sixth optical surface; the optical signal transmitted through the sixth optical surface is transmitted to the first optical surface; the third optical surface faces the second optical fiber adapter; the fourth optical surface faces the third optical surface and the optical reception chip; and the optical reception chip is located below the fourth optical surface and between the optical axis of the first optical fiber adapter and the optical axis of the second optical fiber adapter.

2. The optical module according to claim 1, wherein the first optical surface is configured to change a direction of the emission optical signal in a width direction and a length direction of the circuit board; and the third optical surface is configured to change a direction of the reception optical signal in the length direction and the width direction of the circuit board, so as to transmit an emission optical signal generated by the optical emission chip to the first optical fiber adapter, and to transmit a reception optical signal input via the second optical fiber adapter to the optical reception chip.

3. The optical module according to claim 2, wherein a top of the lens assembly body is formed with a first recess portion, and a bottom of the first recess portion is formed with a first groove, a second groove, a third groove and a fourth groove;
the first optical surface is formed on a side wall of the first groove, and is configured to reflect the emission optical signal toward the first optical fiber adapter; the second optical surface and the fifth optical surface are formed on a bottom of the second groove, and the sixth optical surface is formed on a side wall of the second groove, the second optical surface is configured to reflect the emission optical signal toward the fifth optical surface, and the sixth optical surface is configured to transmit the emission optical signal toward the first optical surface;
the third optical surface is formed on a side wall of the third groove, and is configured to reflect the reception optical signal input from the second optical fiber adapter; and the fourth optical surface is formed on a side wall of the fourth groove, is located on a reflection optical path of the third optical surface and is configured to reflect an optical signal reflected by the third optical surface toward the optical reception chip.

4. The optical module according to claim 3, wherein a bottom of the lens assembly body is formed with a second recess portion, a fifth groove is arranged on a top surface of the second recess portion, and a bottom of the fifth groove is formed with a seventh optical surface and an eighth optical surface, and wherein the seventh optical surface is located above the optical emission chip and below the second optical surface, and the eighth optical surface is located above the optical reception chip and below the fourth optical surface;
a third lens is disposed on the seventh optical surface, and the third lens is configured to collimate the emission optical signal generated by the optical emission chip; and a fourth lens is disposed on the eighth optical surface, and the fourth lens is configured to converge the reception optical signal toward the optical reception chip.

5. The optical module according to claim 3, wherein the first optical fiber adapter is formed thereon with a first through hole, and a first fiber ferrule is disposed in the first through hole; the lens assembly body is formed thereon with a first blind hole, the first blind hole being located on an optical path from the first optical fiber adapter to the first optical surface; and
one end of the first blind hole is communicated to the first through hole, a first lens is disposed at another end of the first blind hole, and the first lens is configured to converge an optical signal from the first optical surface and transmit it to the first fiber ferrule.

6. The optical module according to claim 3, wherein the second optical fiber adapter is formed thereon with a second through hole, and a second fiber ferrule is disposed in the second through hole; the lens assembly body is further formed thereon with a second blind hole, the second blind hole being located on an optical path from the second optical fiber adapter to the third optical surface; and
one end of the second blind hole is communicated to the second through hole, a second lens is disposed at another end of the second blind hole, and the second lens is configured to collimate a reception optical signal transmitted via the second fiber ferrule and transmit it to the third optical surface.

7. The optical module according to claim 1, wherein the center of the optical emission chip is located between a projection of the optical axis of the first optical fiber adapter on the circuit board and a projection of the optical axis of the second optical fiber adapter on the circuit board; and the center of the optical reception chip is located between the projection of the optical axis of the first optical fiber adapter on the circuit board and the projection of the optical axis of the second optical fiber adapter on the circuit board.

8. The optical module according to claim 1, wherein the optical emission chip and the optical reception chip share a driver chip, and a length of the driver chip is less than the distance between the optical axis of the first optical fiber adapter and the optical axis of the second optical fiber adapter.

9. The optical module according to claim 3, wherein a backlight monitor chip is disposed on a surface of the circuit board; and the lens assembly is located above the backlight monitor chip, and the backlight monitor chip receives an optical signal reflected by the fifth optical surface and performs emission power monitoring of the optical module.

10. The optical module according to claim 9, wherein the second optical surface and the fifth optical surface intersect in the second groove.

11. The optical module according to claim 9, wherein the second groove is further formed therein with a first plane, the second optical surface is located at one side of the first plane, the fifth optical surface is located at another side of the first plane, and the second optical surface and the fifth optical surface are not symmetric about a central axis of the first plane.

12. The optical module according to claim 11, wherein the first plane is perpendicular to an optical axis of the optical emission chip.

13. The optical module according to claim 9, wherein the backlight monitor chip comprises a first backlight monitor chip located between the optical emission chip and the optical reception chip;
a bottom of the lens assembly body is formed with a ninth optical surface, the ninth optical surface being located above the first backlight monitor chip, and the fifth optical surface is configured to reflect a portion of the emission optical signal, and the emission optical signal reflected by the fifth optical surface is transmitted to the ninth optical surface; and
a fifth lens is disposed on the ninth optical surface, and the fifth lens is configured to converge the emission optical signal toward the first backlight monitor chip.

14. The optical module according to claim 9, wherein the backlight monitor chip comprises a second backlight monitor chip located at a side of the optical emission chip away from the optical reception chip;
a bottom of the lens assembly body is formed with a tenth optical surface, the tenth optical surface being located above the second backlight monitor chip; and
the sixth optical surface is configured to reflect a portion of the emission optical signal, emission optical signal reflected by the sixth optical surface is transmitted to and transmitted through the fifth optical surface, the optical signal transmitted through the fifth optical surface is transmitted to the second optical surface and, after being reflected by the second optical surface, is transmitted to and transmitted through the tenth optical surface, and then transmitted to the second backlight monitor chip.

15. The optical module according to claim 9, wherein the bottom of the first recess portion is formed with a sixth groove, and an eleventh optical surface is formed in the sixth groove; and
the center of the optical reception chip is located on a projection of the optical axis of the second optical fiber adapter on the circuit board, the eleventh optical surface faces the second optical fiber adapter and the optical reception chip, and the eleventh optical surface is located above the optical reception chip.

16. The optical module according to claim 15, wherein a distance between the optical emission chip and a projection of the optical axis of the first optical fiber adapter on the circuit board is equal to a distance between the center of the optical reception chip and the projection of the optical axis of the second optical fiber adapter on the circuit board.

17. The optical module according to claim 9, wherein a twelfth optical surface is formed on the lens assembly body; the second optical surface is located above the twelfth optical surface, and the twelfth optical surface is located above the optical emission chip; the twelfth optical surface is located at one side of the seventh optical surface close to a part of the lens assembly body connected to the first optical fiber adapter; the emission optical signal reflected by the fifth optical surface is transmitted to the second optical surface, and is reflected by the second optical surface to the twelfth optical surface; and the twelfth optical surface refracts the optical signal to the backlight monitor chip.

18. The optical module according to claim 17, wherein the twelfth optical surface is formed at a top of the second recess portion.

19. The optical module according to claim 17, wherein a driver chip is disposed on the surface of the circuit board, the optical emission chip and the optical reception chip are electrically connected to the driver chip, respectively, and the driver chip is disposed at sides of the optical emission chip and the optical reception chip away from an optical port of the optical module; the backlight monitor chip comprises a third backlight monitor chip; and
the third backlight monitor chip is located at a side of the optical emission chip close to the optical port, and is located below the twelfth optical surface.

20. The optical module according to claim 17, wherein a driver chip is disposed on the surface of the circuit board, the optical emission chip and the optical reception chip are electrically connected to the driver chip, respectively, and the driver chip is disposed at sides of the optical emission chip and the optical reception chip away from an optical port of the optical module; and
the backlight monitor chip comprises a fourth backlight monitor chip located at an obliquely diagonal side of the optical emission chip close to the optical port and away from the optical reception chip, and the fourth backlight monitor chip is located below the twelfth optical surface.
